(19) United States
(12) Patent Application Publication
(10) Pub. No.: US 2014/0325439 A1
(43) Pub. Date: Oct. 30, 2014

(54) METHOD FOR OUTPUTTING IMAGE AND ELECTRONIC DEVICE THEREOF

(71) Applicant: Samsung Electronics Co., Ltd., Suwon-si (KR)

(72) Inventors: Jae-Sik SOHN, Suwon-si (KR); Ki-Huk LEE, Yongin-si (KR); Min-Chul KIM, Busan (KR); Young-Kwon YOON, Seoul (KR); Yong-Hwan KIM, Cheongju-si (KR); Jung-Uk LIM, Gumi-si (KR)

(73) Assignee: Samsung Electronics Co., Ltd., Suwon-si (KR)

(21) Appl. No.: 14/260,761

(22) Filed: Apr. 24, 2014

(30) Foreign Application Priority Data
Apr. 24, 2013 (KR) 10-2013-0045568
Aug. 29, 2013 (KR) 10-2013-0103326

(51) Int. Cl. G06F 3/0484; G06F 3/0482

(52) U.S. Cl. CPC G06F 3/04845; G06F 3/0482
USPC 715/810

(57) ABSTRACT

An electronic device is provided. The electronic device includes a display and a processor. The processor is configured to output a first synthesized image expressing a state of an object via the display, to output preview information of an object used for the first synthesized image, to select at least one object from the first synthesized image in response to an input, to detect an input to edit an original image corresponding to the selected at least one object, and to generate and output a second synthesized image based on an object of the edited original image.

### CROSS-REFERENCE TO RELATED APPLICATION(S)

This application claims the benefit under 35 U.S.C. §119(a) of a Korean patent application filed on Apr. 24, 2013 in the Korean Intellectual Property Office and assigned Serial number 10-2013-0045568, and of a Korean patent application filed on Aug. 29, 2013 in the Korean Intellectual Property Office and assigned Serial number 10-2013-0103326, the entire disclosure of each of which is hereby incorporated by reference.

### TECHNICAL FIELD

The present disclosure relates to a method for outputting an image and an electronic device thereof.

### BACKGROUND

Currently, with rapid development of an electronic device, an electronic device that allows information or data exchange is widely used.

Generally, the electronic device has a display means and an input means, and supports an image output function.

In addition, the electronic device may provide a function for editing an image obtained via a camera or an image stored in advance.

The electronic device may provide an image edit function such as image color correction, character insertion, image synthesis, and the like.

The electronic device may synthesize a plurality of images as one image, and extract an object included in the plurality of images to synthesize one image.

Accordingly, an electronic device for detecting an input for an image to extract a portion corresponding to the input, or determining an object via an image analysis result, and extracting the determined object is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device for detecting an input for an image to extract a portion corresponding to the input, or determining an object via an image analysis result, and extracting the determined object.

The electronic device cannot accurately discriminate a background and an object from an image, so that the electronic device may extract a background of a predetermined region together using a determined object as a reference.

However, in case of performing an image synthesis process using an object extracted together with a background, an unnatural synthesis image may be generated due to the background around the object.

Accordingly, an aspect of the present disclosure is to provide an apparatus and a method for providing preview information of an object in a synthesized image that has synthesized an image where a moving object has been successively shot in an electronic device.

Another aspect of the present disclosure is to provide an apparatus and a method for editing an original image corresponding to a selected object by detecting an input in an electronic device.

Still another aspect of the present disclosure is to provide an apparatus and a method for generating a synthesized image using an object of an original image from which a neighboring background has been removed in an electronic device.

Yet another aspect of the present disclosure is to provide an apparatus and a method for displaying an original image of an object to edit by detecting an input of a synthesized image in an electronic device.

Still yet another aspect of the present disclosure is to provide an apparatus and a method for applying an edit effect to preview information corresponding to an object depending on object editing of a synthesized image in an electronic device.

Yet further another aspect of the present disclosure is to provide an apparatus and a method for changing a position of an object forming a synthesized image, and changing a position of preview information corresponding to the object whose position has been changed.

Yet still further another aspect of the present disclosure is to provide an apparatus and a method for providing preview information based on an object selected by an input in the case where a plurality of objects exist in an image forming a synthesized image in an electronic device.

Still further another aspect of the present disclosure is to provide an apparatus and a method for changing a combination of an original image to provide a plurality of candidate images in an electronic device.

Still yet further another aspect of the present disclosure is to provide an apparatus and a method for discriminating successively shot objects using layers, and correcting other layers simultaneously depending on a condition when one layer is edited.

In accordance with an aspect of the present disclosure, an electronic device for outputting an image is provided. The electronic device includes a display and a processor, wherein the processor is configured to output a first synthesized image expressing a state of an object, to output preview information regarding an object used for the first synthesized image, to select at least one object from the first synthesized image in response to an input, to detect an input to edit an original image corresponding to the selected object, and to generate and output a second synthesized image based on the selected object of the edited original image.

In accordance with another aspect of the present disclosure, a method for outputting an image in an electronic device is provided. The method includes extracting an object where movement has occurred from one or more images, generating and outputting a first synthesized image based on the extracted object, selecting at least one object from the first synthesized image in response to an input, and detecting an input to edit an original image of the selected object, and generating a second synthesized image based on the selected object of the edited original image.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to an embodiment of the present disclosure;

FIG. 2 is a flowchart illustrating a process for outputting a synthesized image in an electronic device according to an embodiment of the present disclosure;

FIG. 3 is a flowchart illustrating a process for selecting an object included in a synthesized image in an electronic device according to an embodiment of the present disclosure;

FIG. 4 is a flowchart illustrating a process for editing an object included in a synthesized image in an electronic device according to an embodiment of the present disclosure;

FIG. 5 is a flowchart illustrating a process for generating a candidate list for a synthesized image in an electronic device according to an embodiment of the present disclosure;

FIG. 6 is a flowchart illustrating a process for providing preview information of a synthesized image in an electronic device according to an embodiment of the present disclosure;

FIGS. 7A, 7B, and 7C are views illustrating a screen that outputs a synthesized image in a general electronic device according to an embodiment of the present disclosure;

FIGS. 8A and 8B are views illustrating a screen that outputs a synthesized image in an electronic device according to an embodiment of the present disclosure;

FIGS. 9A, 9B, and 9C illustrate a view illustrating a process for editing an object forming a synthesized image in an electronic device according to an embodiment of the present disclosure;

FIGS. 10A, 10B, 10C, and 10D are views illustrating another process for editing an object forming a synthesized image in an electronic device according to an embodiment of the present disclosure;

FIGS. 11A, 11B, 11C, and 11D are views illustrating a process for editing a synthesized image in an electronic device according to an embodiment of the present disclosure;

FIGS. 12A, 12B, 12C, 12D, 12E, 12F, 12G, 12H, and 12I are views illustrating a process for generating a synthesized image in an electronic device according to an embodiment of the present disclosure;

FIGS. 13A, 13B, and 13C are views illustrating a process for generating a synthesized image in an electronic device according to an embodiment of the present disclosure;

FIG. 14 is a flowchart illustrating a process for generating a synthesized image in an electronic device according to an embodiment of the present disclosure;

FIG. 15 is a flowchart illustrating a process for editing a synthesized image in an electronic device according to an embodiment of the present disclosure;

FIGS. 16A, 16B, and 16C are views illustrating an image edit operation according to an embodiment of the present disclosure;

FIG. 17 is a flowchart illustrating a process for setting a masking effect in an electronic device according to an embodiment of the present disclosure;

FIG. 18 is a view illustrating a masking effect of a synthesized image according to an embodiment of the present disclosure; and

FIGS. 19A and 19B are views illustrating an object restoration process of an electronic device according to an embodiment of the present disclosure.

Throughout the drawings, like reference numerals will be understood to refer to like parts, components and structures.

### DETAILED DESCRIPTION OF THE DRAWINGS

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A touchscreen variously used recently is an input or display unit that performs input and display of information via one screen. Accordingly, in case of using the touchscreen, the electronic device may remove a separate input unit such as a keypad to increase a display area. For example, in case of using a full-touch type that applies a touchscreen to an entire screen, the electronic device may utilize an entire screen of the electronic device as a screen to increase a screen size.

The electronic device may output an image (a synthesized image) that synthesizes a plurality of images expressing a state change of an object in one background using the increased screen size.

The electronic device may extract an object from successively shot images, and synthesize a plurality of objects in a background image, thereby generating a synthesized image. Here, the synthesized image may be one image that expresses a state change (movement) of an object.

The electronic device may extract an object based on an image analysis result, but it is difficult to discriminate a background and an object, so that the electronic device may extract an object including a background of a predetermined region using a determined object as a reference.

To prevent an object from being hidden by other objects and quality of a synthesized image from deteriorating, the electronic device may generate a synthesized image using objects that do not overlap each other among a plurality of extracted objects. According to an embodiment, in case of determining an object extracted from a first image and an object extracted from a second image overlap each other, the electronic device may exclude one of the two objects from the synthesized image.

Therefore, the electronic device may generate a synthesized image using a limited number of objects.

In the description below, the electronic device according to an embodiment of the present disclosure may remove a portion of a background included in an object to improve the quality of the synthesized image, and increase the number of objects added to the synthesized image.

The electronic device may detect an input to select an object included in the synthesized image. In case of detecting an input of the synthesized image to select an object, the electronic device may activate preview information of an original image corresponding to the selected object. According to an embodiment, the electronic device may apply an effect informing the selection to the preview information corresponding to the selected object, or make the magnitude of the preview information corresponding to the selected object different from the magnitude of another preview information. Here, the preview information for the object may include a thumbnail image which is a preview image of an original image, and may include text type list information of the original image, and the like.

The electronic device may detect an input to perform an editing process on the original image corresponding to the selected object in the synthesized image. According to an embodiment, the electronic device may perform an editing process including a position change of the selected object, duplication of the selected object, deletion of the selected object, effect application, and the like, such as an emoticon on the original image corresponding to the selected object.

The electronic device may provide a candidate image that has changed a combination of objects based on the original image. According to an embodiment, the electronic device may change a combination method with consideration of an interval of objects included in the original image to determine a plurality of candidate images, and generate preview information of the determined candidate image to output the same. The electronic device may update a candidate image for preview information corresponding to an input using a synthesized image, and provide the same.

The electronic device may select an object to be used for a synthesized image from an image including a plurality of objects, and provide preview information based on the selected object.

In addition, the electronic device may be a portable electronic device, and may be a device such as a portable terminal, a mobile terminal, a media player, a tablet computer, a handheld computer, and a Personal Digital Assistant (PDA). Also, the electronic device may be an arbitrary portable electronic device including a device combining two or more functions among these devices. According to another embodiment, the electronic device may include any kind of an electronic device including a display and an input means. For example, the electronic device may include a desktop computer, a multi-function peripheral, a video game console, a digital camera, a Mobile Internet Device (MID), an Ultra Mobile PC (UMPC), a navigation, a smart TV, a digital watch, and an MP3 player, but is not limited thereto.

Embodiments below describe an electronic device including a touchscreen. However, a person of ordinary skill in the art would have easily understood embodiments described in the present specification are properly applicable to an electronic device, or a computing device having a display and another input means even though it does not include a touchscreen.

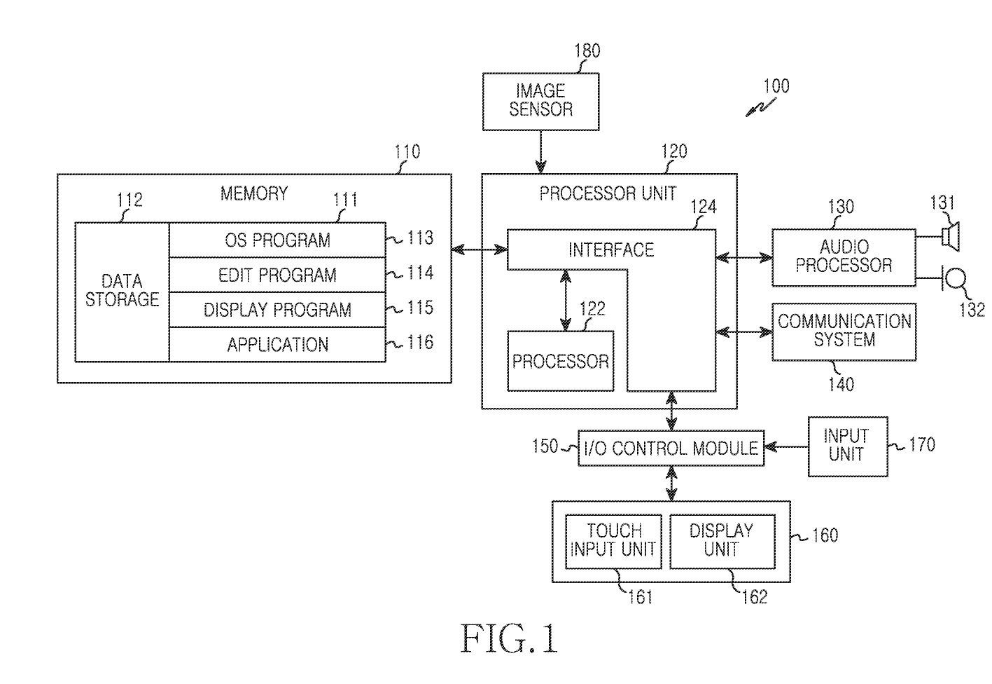

FIG. 1 is a block diagram illustrating an electronic device according to an embodiment of the present disclosure.

As illustrated in FIG. 1, the electronic device 100 may include a memory 110, a processor unit 120, an audio processor 130, a communication system 140, an Input/Output (I/O) control module 150, a touchscreen 160, an input unit 170, and an image sensor 180. Here, one or more of the above-mentioned elements may be configured in the plural. For example, the electronic device may include a plurality of memories 110 and communication systems 140.

The memory 110 may include a program storage 111 for storing a program for controlling an operation of the electronic device 100, and a data storage 112 for storing data occurring during execution of a program. For example, the data storage 112 may store various updatable data for storage such a phonebook (not illustrated), calling messages (not illustrated), and received messages (not illustrated), and according to an embodiment of the present disclosure, may store a plurality of images (original images) (not illustrated) that express a state change of an object, and a synthesized image synthesized using the image. According to an embodiment, the data storage 112 may store an image shot (not illustrated) with a predetermined time interval, and a synthesized image where an object extracted from the image has been synthesized in one background.

The data storage 112 may store preview information of an image that may be used for a synthesized image.

The data storage 112 may store original image information for each object included in the synthesized image, preview image information, and information regarding a synthesized position of each object.

The program storage 111 may include an Operating System (OS) program 113, an edit program 114, a display program 115, and at least one application 116. Here, a program included in the program storage 111 is a set of instructions, and may be expressed as an instruction set.

The OS program 113 may include various software elements for controlling a general system operation. A control of this general system operation, for example, may mean memory management and control, storage hardware (device) control and management, power control and management, and the like. This OS 113 may also perform a function for swift communication between various hardware (devices) and program elements (modules).

The edit program 114 may include various software elements for controlling to generate a synthesized image, and edit the generated synthesized image. According to an embodiment, the edit program 114 may separate a background and an object included in an image, and synthesize a plurality of separated objects in one background.

The edit program 114 may remove a background of the original image corresponding to an object forming a synthesized image in response to an input.

The edit program 114 may select an object included in a synthesized image in response to an input.

The edit program 114 may perform an editing process on a selected object in a synthesized image in response to an input. According to an embodiment, the edit program 114 may perform an editing process including a position change of the selected object, duplication of the selected object, deletion of the selected object, effect application, and the like, such as an emoticon on the selected object.

The edit program 114 may provide a candidate image that has changed a combination of the original image that may be used for the synthesized image. According to an embodiment, the edit program 114 may adjust an interval of objects included in the original image to determine a plurality of candidate images, and generate preview information of the determined candidate image.

The edit program 114 may select an object to be used for a synthesized image from an image including a plurality of objects, and provide preview information based on the selected object. The edit program 114 may generate a synthesized image from which some of objects have been excluded in an image including a plurality of objects.

The edit program 114 may define an edit object based on an edit section and an overlapping state of a first original image selected as an edit object.

In the case where an edit section is included in a first original image with the first original image disposed lower than an overlapping second original image, the edit program 114 may remove a region of the first original image corresponding to the edit section.

In the case where an edit section deviates from the first original image with the first original image disposed lower than the overlapping second original image, the edit program 114 may extend a region of the first original image corresponding to the edit section.

In the case where an edit section is included in the second original image with the first original image disposed lower than an overlapping second original image, the edit program 114 may remove a region of the second original image corresponding to the edit section.

The edit program 114 may apply a masking effect to the original image defined as an edit object, and remove the masking effect or restore a removed masking effect for a region corresponding to an input.

The edit program 114 may apply a masking effect to the original image defined as an edit object, and in the case where the first original image defined as the edit object overlaps the second original image, the edit program 114 may remove a masking effect of the first original image with respect to the overlapped portion.

The display program 115 may include various software elements for providing and displaying graphics on the touchscreen 160. A terminology of graphics may be used in the meaning including text, a web page, an icon, a digital image, a video, an animation, and the like.

The display program 115 may include various software elements related to a User Interface (UI).

The display program 115 may output a synthesized image generated by the edit program 114.

The display program 115 may output an edit operation where a background of an object is removed depending on an input.

The display program 115 may output preview information corresponding to an object selected by an input for a synthesized image.

The display program 115 may output an editing process of an object selected by an input for a synthesized image. According to an embodiment, the display program 115 may output a position of an object changed by a drag detected in a synthesized image, and also change a position of preview information for the changed object.

The display program 115 may output preview information of a candidate image that has changed a combination of objects based on an original image.

The display program 115 may output a synthesized image generated based on an object selected from an image including a plurality of objects.

A program included in the program storage 111 may be expressed as a hardware configuration. For example, the electronic device may include an OS module, an edit module, and a display module.

The application 116 may include a software element for at least one application installed to the electronic device 100.

The processor unit 120 may include at least one processor 122 and an interface 124. Here, the processor 122 and the interface 124 may be integrated in at least one Integrated Circuit (IC) or implemented as separate elements.

The interface 124 may serve as a memory interface for controlling an access of the processor 122 and the memory 110.

In addition, the interface 124 may serve as a peripheral interface for controlling connection between an I/O peripheral and the processor 122 of the electronic device 100.

The processor 122 may edit an original image corresponding to an object included in the synthesized image using at least one software program. According to an embodiment, the processor 122 may execute at least one program stored in the memory 110 to perform a function corresponding to the relevant program. For example, the processor 122 may include a control processor for generating the synthesized image, removing a background of an original image of an object included in the synthesized image, and changing a position of the object included in the synthesized image.

A function control of the electronic device according to an embodiment of the present disclosure may be performed using a software such as a program stored in the memory 110 or a hardware such as the control processor.

The audio processor 130 may provide an audio interface between a user and the electronic device 100 via a speaker 131 and a microphone 132.

The communication system 140 may perform a communication function for voice communication and data communication of the electronic device 100. The communication system 140 may be divided into a plurality of sub modules supporting different communication networks. According to an embodiment, though not limited thereto, the communication network may include a Global System for Mobile Communication (GSM) network, an Enhanced Data GSM Environment (EDGE) network, a Code Division Multiple Access (CDMA) network, a Wide-CDMA (W-CDMA) network, a Long Term Evolution (LTE) network, an Orthogonal Frequency Division Multiple Access (OFDMA) network, a wireless LAN, a Bluetooth network, a Near Field Communication (NFC), but is not limited thereto.

The I/O control module 150 may provide an interface between an I/O unit such as a touchscreen 160, an input unit 170, and the like, and the interface 124.

The touchscreen 160 is an I/O unit for performing output of information and input of information, and may include a touch input unit 161 and a display unit 162.

The touch input unit 161 may provide touch information detected via a touch panel to the processor unit 120 via the I/O controller 150. The touch input unit 161 changes touch information to an instruction structure such as touch_down, touch_move, and touch_up, and provides the same to the processor unit 120. According to an embodiment of the present disclosure, the touch input unit 161 may generate a user's gesture for allowing the user to select an object from the synthesized image, and the user's gesture for removing a background of an object included in the synthesized image.

The display unit 162 may display state information of the electronic device 100, a character input by the user, a moving picture, a still picture, but is not limited thereto. For example, the display unit 162 may output a synthesized image edited depending on an input.

For example, the display unit 162 may output an edit operation where a background of an object is removed depending on an input.

The display unit 162 may output an original image corresponding to an object selected by an input for a synthesized image, and preview information for an original image corresponding to the selected object.

The display unit 162 may output an editing process for an object selected by an input for the synthesized image, a candidate image that has changed a combination of an original image, and a synthesized image generated based on a reference object selected from an image including a plurality of objects.

Though not shown, the touchscreen 160 may include a capacitive touch panel, a touch panel controller, a display panel, a digitizer pad, a digitizer pad controller, and the like.

The input unit 170 may provide input data generated by the user's selection to the processor unit 120 via the I/O controller 150. According to an embodiment, the input unit 170 may include only a control button for controlling the electronic device 100. According to another embodiment, the input unit 170 may include a keypad for receiving input data from the user. According to an embodiment of the present disclosure, the input unit 170 may generate a user's gesture for allowing the user to select an object from the synthesized image, and the user's input for removing a background of an object included in the synthesized image.

The image sensor 180 may perform a camera function such as a photo and a video clip recording. The image sensor 180 may be disposed on the front side and/or the backside of the electronic device 100. Though not shown, the electronic device may further include an optical portion, a signal processor, and the like.

The optical portion may be driven by a mecha-shutter (not illustrated), a motor (not illustrated), and an actuator (not illustrated), and may perform an operation such as zooming, focusing, and the like, via the actuator. The optical portion may shoot a neighbor image, and the image sensor may detect an image shot by the optical portion and convert the same to an electric signal. Here, the image sensor may be a Complementary Metal Oxide Semiconductor (CMOS) and/or a Charged Coupled Device (CCD) sensor, and may be a high resolution image sensor. The image sensor of the camera may mount a global shutter therein. The global shutter may perform a function similar to a mecha-shutter built in the sensor.

The image sensor 180 according to an embodiment of the present disclosure may operate continuously for a predetermined time to obtain a plurality of images expressing a state (movement) of an object. According to an embodiment, the image sensor 180 may obtain a plurality of images where a background of the image is the same and a position of an object changes.

Though not shown, the electronic device 100 may further include elements for providing additional functions such as a broadcast reception module for receiving broadcasting, a digital sound source reproduction module such as an MP3 module, a proximity sensor module for proximity sensing, and the like, and a software for operations of these.

According to an embodiment, an electronic device for outputting an image may include a display and a processor, and the processor may be configured to output a first synthesized image expressing a state of an object, output preview information of an object used for the first synthesized image, select at least one object from the first synthesized image, detect an input to edit an original image corresponding to the selected object, and generate a second synthesized image based on an object of the edited original image to output the same.

According to an embodiment, the processor may be configured to detect at least one of an input of the first synthesized image, and an input of preview information and determine an original image for an object to edit.

According to an embodiment, the processor may be configured to remove a background around an object from an original image corresponding to a selected object or add the background.

According to an embodiment, the processor may be configured to change a position of a selected object using an input of the first synthesized image, and also change arrangement of preview information corresponding to the changed position.

According to an embodiment, the processor may be configured to determine an object selected by an input from an image including a plurality of images, and provide preview information based on the selected object.

According to an embodiment, the processor may be configured to change a combination of an original image to generate a candidate image, and output preview information of the generated candidate image.

According to an embodiment, the processor may be configured to use a candidate image for preview information selected by an input as a second synthesized image.

According to an embodiment, the processor may be configured to select an object to edit from the first synthesized image and apply an effect to preview information of the selected object.

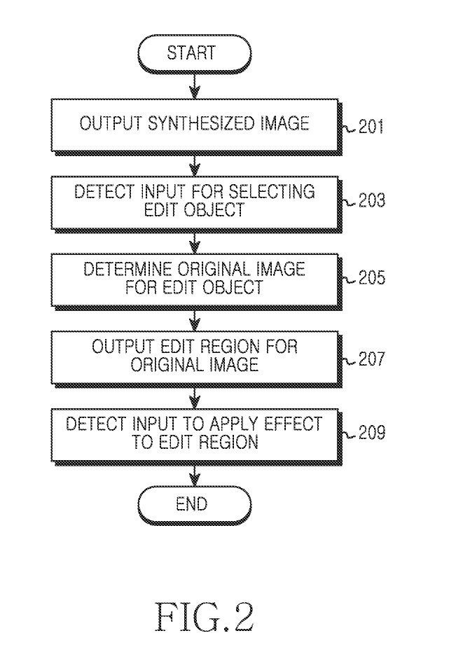

FIG. 2 is a flowchart illustrating a process for outputting a synthesized image in an electronic device according to an embodiment of the present disclosure.

Referring to FIG. 2, the electronic device may extract an object from successively obtained (shot) images (original images), and synthesize respectively extracted objects in one of images including a background. For example, the electronic device may obtain a plurality of images where a background is the same and the position of a ball changes by successively shooting a flying ball with a shooting position fixed. The electronic device may extract a ball from a background of each image, and synthesize respectively extracted balls in one of images including a background to express an orbit on which the ball moves.

The electronic device may compare successive images to determine an object whose state changes, and extract a background from the determined object. However, since it is difficult for the electronic device to accurately extract an object from a background, the electronic device may extract an object including a background of a predetermined region around the determined object via an image analysis result. That is, the electronic device cannot accurately extract a ball from the background of an image, so that the electronic device may extract a wider region than the shape of a ball.

A periphery of the above-extracted object may include the background of a predetermined region, and the electronic device may generate a synthesized image based on objects that do not overlap each other.

According to an embodiment, the electronic device may exclude an object hiding another object from a synthesized image.

This synthesized image generation method may limit the number of objects included in a synthesized image so that objects do not overlap each other. This is because, in case of an increasing the number of objects, another object may be hidden by a partial background included in the object as described above. The electronic device according to an embodiment of the present disclosure may remove a partial background included in an object to increase the number of objects included in a synthesized image, and make disposition of the object natural.

To perform these operations, the electronic device may output a synthesized image (a first synthesized image) in operation 201. Here, the synthesized image is an image representing a synthesized result, and is not an actually synthesized image but may be a synthesized image before the image is stored in the electronic device.

The electronic device may output a synthesized image formed of an object including a partial background, and store an original image for an object to be used for a synthesized image. Here, the original image for the each object denotes an original image including the object to be used for the synthesized image. The electronic device may analyze the original image to determine an original image appropriate for generating a synthesized image, and extract an object from the original image determined as appropriate to generate a synthesized image.

The electronic device may provide preview information of the original image (the image determined as appropriate for synthesis among shot images) that may be used for a synthesized image, and an original image for selected preview information may be used for a synthesized image, and an original image for an unselected preview information may be excluded from a synthesized image.

The electronic device may define an original image of an edit object even via an object list expressed in the form of text instead of preview information.

The electronic device may detect an input selecting an edit object in operation 203, and determine an original image for the selected edit object in operation 205.

The input for selecting the edit object may be an input for selecting an object to edit from an output synthesized image, and an input for selecting preview information to edit among output preview information.

The electronic device may output an edit region for an original image corresponding to an input in operation 207. Here, the edit region is an editable region for the original image, and the electronic device may define the edit region with respect to a portion of a background included in the at least original image. For example, the electronic device may define an entire region of the original image, an object including a partial background included in the original image, and the like, as the edit region.

The electronic device may detect an input to apply an edit effect to an edit region in operation 209. The electronic device may apply an edit effect by removing a portion where an input has been detected from the edit region, or restoring a portion that has been removed by an input.

For example, the electronic device may apply a masking effect to an edit region, detect an input such as a user's finger, an electronic pen, and the like, and remove a masking effect of an input-detected portion to use only the finally remaining region for the masking effect as an object.

The electronic device may apply an edit effect by adding text data or image data to an input-detected portion among the edit region.

The electronic device may generate a new synthesized image (a second synthesized image) using an edit effect-applied original image. According to an embodiment, the electronic device may remove a partial background included in an object via a delicacy operation and generate a synthesized image using the background-removed object.

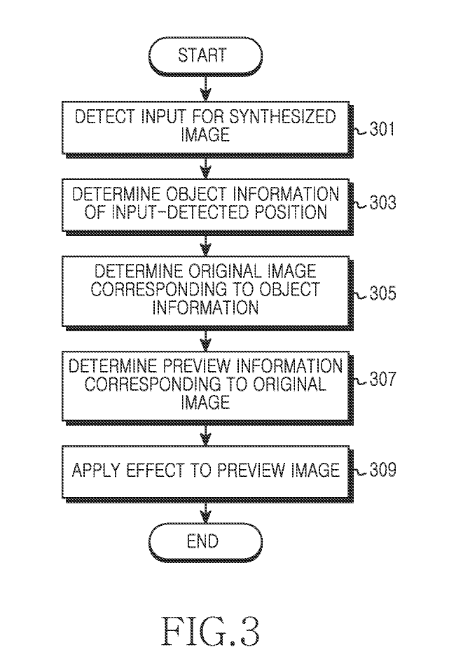

FIG. 3 is a flowchart illustrating a process for selecting an object included in a synthesized image in an electronic device according to an embodiment of the present disclosure.

The electronic device may output preview information forming a synthesized image together when outputting the synthesized image.

The electronic device may detect an input regarding preview information to define an original image of an object to edit.

Referring to FIG. 3, the electronic device may detect an input for a synthesized region to select an object corresponding to an edit object.

In case of detecting an input for an output synthesized image and selecting an object, the electronic device may add a mark informing the selection to preview information for the selected object. For example, the electronic device may allow the magnitude of the preview information regarding the selected object to be different from that of another preview information, and/or may give a characteristic color, and a mark to the preview information regarding the selected object.

To perform the above operation, the electronic device may detect an input for a synthesized image in operation 301. For example, the electronic device may detect an electronic pen input, a finger input, a hover input, and the like, that selects at least one object included in a synthesized image, and determines a position where the input has been detected.

The electronic device may determine object information regarding the position where the input has been detected in operation 303. The electronic device may store information such as position information, the magnitude of each synthesized object, an edit region (a masking effect region) of each synthesized object, and the like, when generating a synthesized image, and compare stored information with detected position information to determine an object selected by an input.

The electronic device may determine an original image corresponding to object information in operation 305, and determine preview information corresponding to the original image in operation 307.

The electronic device may apply an effect to a preview image in operation 309. To discriminate a preview image for a selected object in a synthesized region, the electronic device may perform operations of giving a check mark to a check box of preview information corresponding to the selected object, adjusting the magnitude of the preview information corresponding to the selected object, or applying color information defined in advance to the preview information corresponding to the selected object.

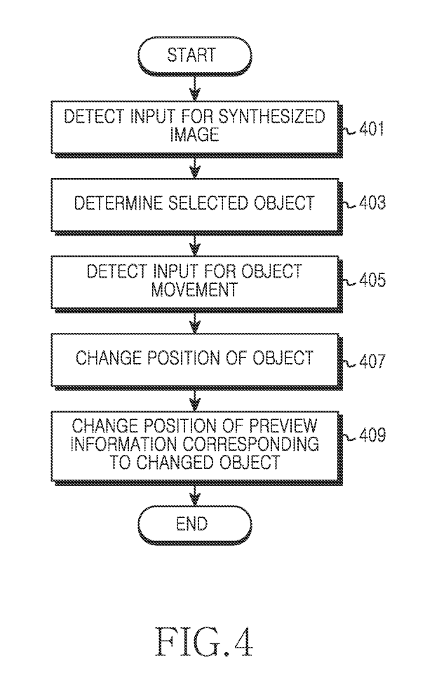

FIG. 4 is a flowchart illustrating a process for editing an object included in a synthesized image in an electronic device according to an embodiment of the present disclosure.

Referring to FIG. 4, an electronic device according to an embodiment of the present disclosure may detect an input for a synthesized region to select an object corresponding to an edit object.

The electronic device may perform an editing process on an original image corresponding to a selected object. Here, the editing process may include operations such as a position change of a selected object, duplication, deletion of the selected object, application of an effect such as an emoticon to the selected object, and the like.

To perform the above operation, the electronic device may detect an input for a synthesized image in operation 401. For example, the electronic device may detect an electronic pen input, a finger input, a hover input, and the like that select at least one object included in a synthesized image, and determine a position where the input has been detected.

The electronic device may determine an object selected by an input in operation 403. As described above, the electronic device may determine the object selected by the input using the input-detected position information and object information stored in advance.

The electronic device may detect an input for moving the selected object in operation 405. Here, the input for moving the object may be a drag input for moving a selected object to a different position on a synthesis screen.

The electronic device may change the position of the selected object to a position corresponding to an input in operation 407.

The electronic device may also change the position of preview information suitable for the changed position of the object in operation 409. According to an embodiment, the electronic device may change the position of a preview image corresponding to the selected object together.

The electronic device may generate a new synthesized image using an object whose position has changed.

Though the present disclosure has described changing the position of an object included in a synthesized image, the electronic device may generate (duplicate) a selected object at a different position, or delete the selected object from a synthesized image. For example, when detecting an input for generating the selected object at a different position in the synthesized image, the electronic device may generate an object which is the same as the selected object, and preview information at a relevant position and dispose the same. When detecting an input for deleting the selected object from the synthesized image, the electronic device may delete the selected object and the preview information.

The electronic device may change a selected object to a different object (ex: an emoticon) in a synthesized image. For example, when detecting the input for changing the selected object to the different object in the synthesized image, the electronic device may output the object that has changed to the different object and preview information.

FIG. 5 is a flowchart illustrating a process for generating a candidate list for a synthesized image in an electronic device according to an embodiment of the present disclosure.

Referring to FIG. 5, the electronic device according to an embodiment of the present disclosure may detect an input for a synthesized region to select an object corresponding to an edit object.

The electronic device may generate a candidate image while changing a combination method for a stored original image when generating a synthesized image. For example, the electronic device may generate a plurality of candidate images by changing a combination method under a circumstance where objects do not overlap each other. According to an embodiment of the present disclosure, since the electronic device may perform an editing process on an object, the electronic device may generate a candidate image for a circumstance where objects overlap each other.

The electronic device that may perform the above operation may analyze an original image that may form a synthesized image in operation 501. Here, the electronic device may analyze an original image to determine a combination method. The electronic device may adjust the number of objects of an original image, an object interval between images, and the like, to determine a combination method.

The electronic device may generate a candidate image that synthesizes an original image using various combination methods in operation 503. For example, in case of storing five original images, the electronic device may generate a candidate image using first, third, and fifth original images, and generate a candidate image using first and fifth original images by changing a combination method. The electronic device may generate various candidate images by changing a combination method.

The electronic device may generate preview information for the generated candidate image in operation 505, and output preview information for the generated candidate image in operation 507.

The electronic device may output preview information for a candidate image, and use a candidate image for selected preview information as a synthesized image. For example, the electronic device may extract an object from original images corresponding to the selected preview information, and generate a synthesized image corresponding to a final synthesized result.

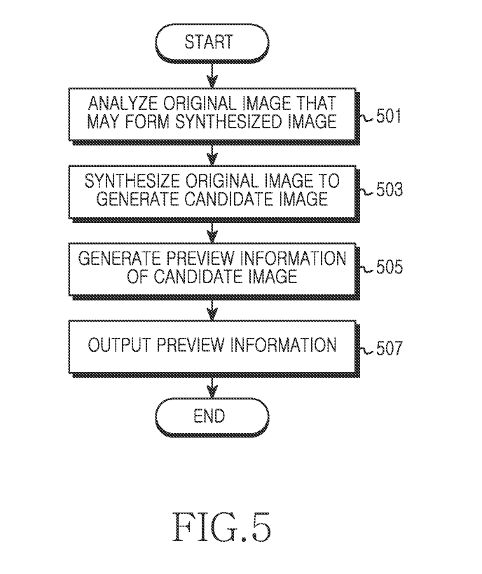

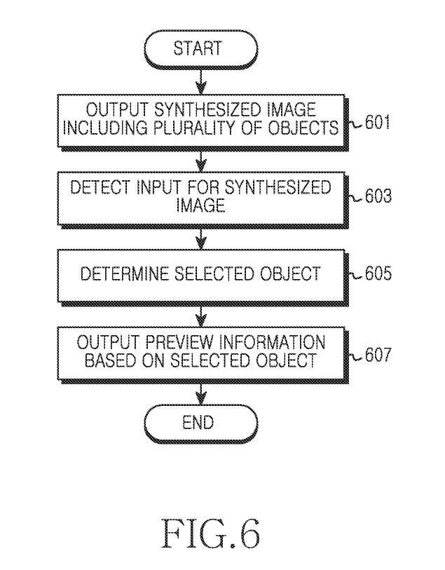

FIG. 6 is a flowchart illustrating a process for providing preview information of a synthesized image in an electronic device according to an embodiment of the present disclosure.

Referring to FIG. 6, the electronic device according to an embodiment of the present disclosure may detect an input for a synthesized region to select an object corresponding to an edit object.

The electronic device may generate a synthesized image based on a state change of the selected object.

According to an embodiment, the electronic device may output preview information corresponding to a first object or preview information corresponding to a second object depending on an input with an image including a plurality of objects whose movement changes output.

To perform the above operation, the electronic device may output an image including a plurality of objects in operation 601.

The electronic device may detect an input for an image in operation 603, and determine a selected object in operation 605. As described above, the electronic device may determine an object selected by an input using input-detected position information and object information stored in advance.

The electronic device may output preview information based on the selected object in operation 607.

For example, the electronic device may output preview information of an original image required for generating a synthesized image based on a state change of the selected object.

For example, the electronic device may assume a state that has output an image expressing movement of a first object and a second object. In addition, it may be assumed that the first object moves at the same speed, and the second object repeats movement and stoppage with a predetermined interval.

In case of determining the first object is selected as a reference object, the electronic device may determine an original image of the first object moving with a predetermined interval, and output preview information of the original image. The electronic device may output preview information of the second object together at a point at which the movement of the first object changes.

For another example, in case of determining the second object is selected as a reference object, the electronic device may determine an original image of the second object at a point at which the second object moves, and output preview information of the original image.

The electronic device may generate a synthesized image using only preview information corresponding to an input among the output preview information.

In case of detecting an input for selecting only one object from an image including a plurality of objects, the electronic device may output preview information of the selected object, and generate a synthesized image formed of selected only one object. The electronic device may also reduce the number of objects added to a synthesized image using selected only preview information among preview information of the selected object for the synthesized image.

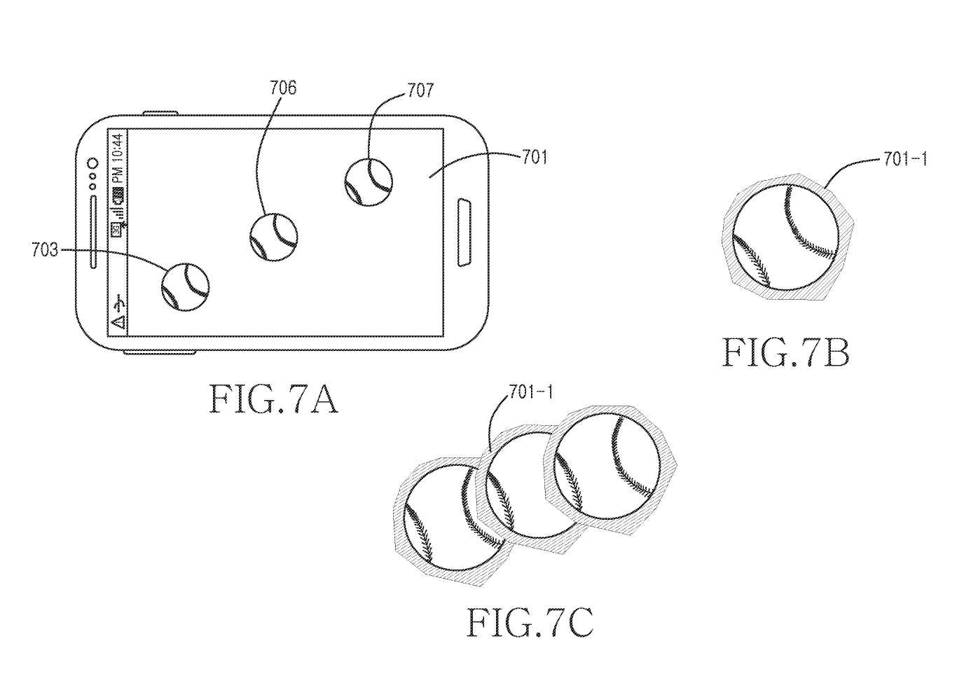

FIGS. 7A to 7C are views illustrating a screen that outputs a synthesized image in a general electronic device according to an embodiment of the present disclosure.

The electronic device may extract an object from successively obtained (shot) images, and synthesize the respectively extracted objects in one of images including a background. For example, the electronic device may obtain a plurality of images where a background is the same and the position of a ball changes by successively shooting the flying ball with a shooting position fixed.

Referring to FIG. 7A, the electronic device may extract a ball from a background of each image, and synthesize respectively extracted balls 703, 706, 707 in an image 701 included in one of the backgrounds to express an orbit on which the ball moves.

Since it is difficult for the electronic device to extract an object from a background, the electronic device may extract an object including a background of a predetermined region using an object determined via an image analysis result as a reference.

Referring to FIG. 7B, the electronic device cannot accurately extract a ball from the background of an image, so that the electronic device may extract a wider region than the shape of the ball. In the illustrated drawing, slashes 701-1 around the ball may denote the background has been extracted together.

The periphery of the extracted object may include a background of a predetermined region, and the electronic device may generate a synthesized image based on objects that do not overlap among the extracted objects.

Referring to FIG. 7C, in the case where the objects including a background 701-1 overlap, an object may be hidden by the background, so that the electronic device may generate a synthesized image using configuration where objects do not overlap at least.

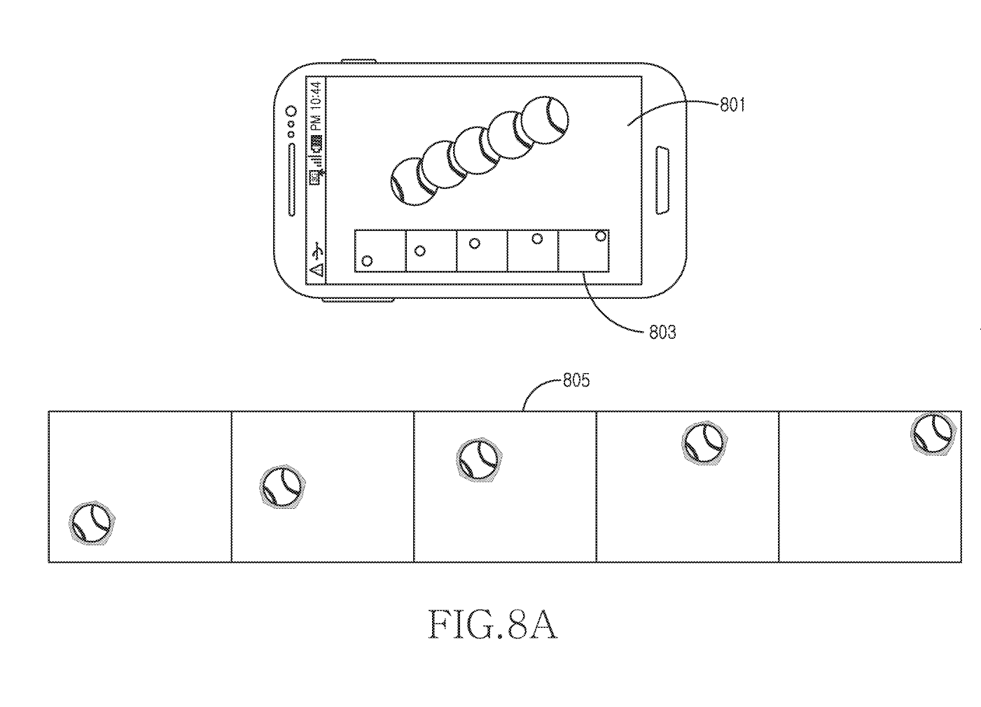

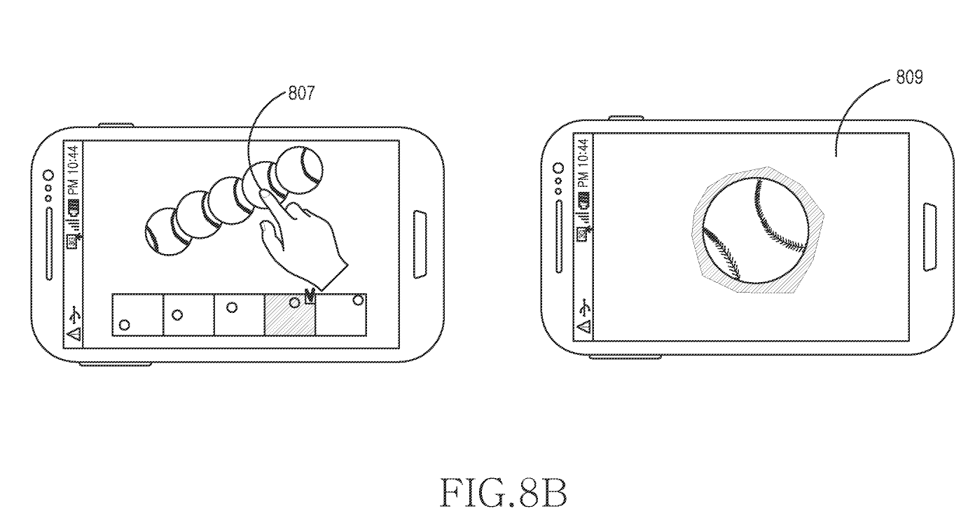

FIGS. 8A to 8B are views illustrating a screen that outputs a synthesized image in an electronic device according to an embodiment of the present disclosure.

Referring to FIG. 8A, the electronic device may output preview information 803 forming a synthesized image together when outputting a synthesized image 801.

The electronic device may detect an input for preview information to define an original image of an object to edit.

However, the preview information 803 is information displaying an original image 805 on a screen of a small size, and due to the small size of the preview information 803, a difficulty in selecting an object to edit may occur.

To solve the problem, in case of detecting an input for a synthesized image to select an object, the electronic device may add a selection mark to the preview information or output an edit region of the original image for the selected object.

Referring to FIG. 8B, when detecting an input 807 for a synthesized region is illustrated, the electronic device may determine the selected object in the synthesized image based on the input, and activate preview information corresponding to the selected object.

For example, the electronic device may store information such as position information of each synthesized object, a magnitude of each synthesized object, an edit region (a masking effect region) of each synthesized object, and the like, when generating a synthesized image. The electronic device may determine a position where an electronic pen input, a finger input, a hover input, and the like, selecting at least one object included in a synthesized region has been detected. According to an embodiment, the electronic device may compare stored information with position information where an input has been detected to determine an object selected by the input, determine an original image corresponding to the selected object, and determine preview information corresponding to the original image.

The illustrated drawing illustrates a circumstance where a shading process and a selection mark are applied to preview information corresponding to an object selected by an input for a synthesized image.

A user may accurately determine preview information for an object corresponding to an edit object, and select this preview information to allow an original image to edit to be output (809).

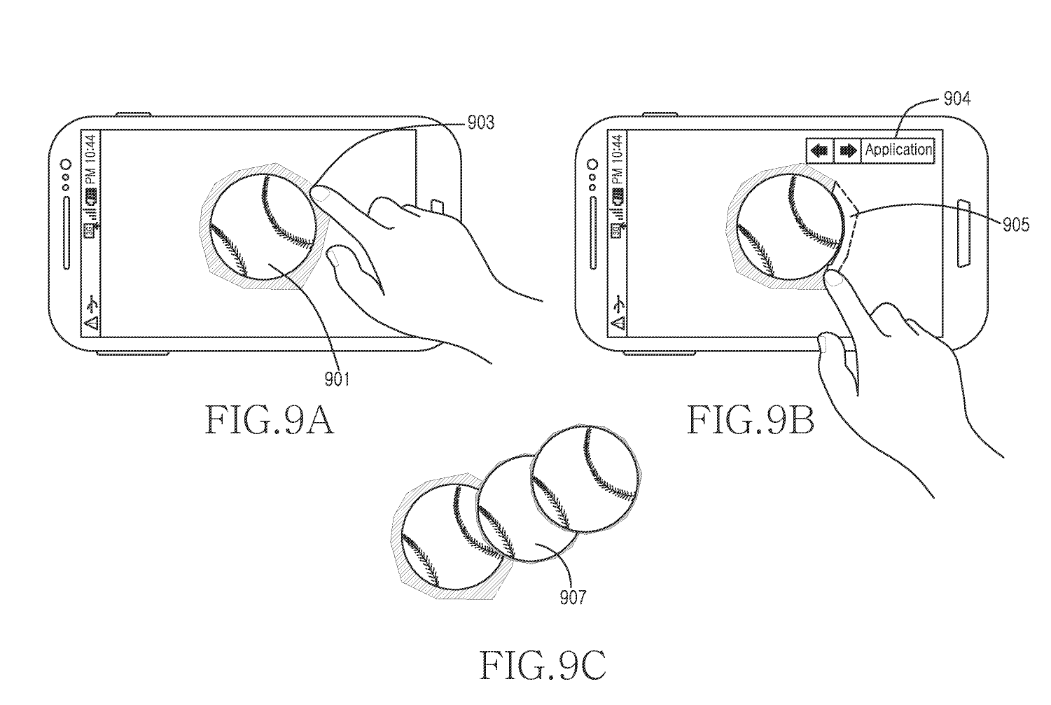

FIGS. 9A to 9C are views illustrating a process for editing an object forming a synthesized image in an electronic device according to an embodiment of the present disclosure.

When an object to edit is selected, the electronic device may display an original image for the object. The electronic device may display an original image corresponding to an object selected by an input for a synthesized image, or display an original image corresponding to preview information selected by an input for preview information output together with a synthesized region.

Referring to FIG. 9A, the original image is an image for an object extracted from a background, and the electronic device may display an object 901 including a partial background.

The electronic device may define an entire region of the original image, an object including a partial background included in the original image, and the like, as an edit region 903, and apply a masking effect to the edit region.

The electronic device may detect an input for a masking effect and remove a masking effect of an input-detected portion.

Referring to FIG. 9B, the electronic device may remove (905) a user input-detected portion, and use only a finally remaining region for a masking effect as an object. The electronic device may extract an object from an original image edited by an input to generate a synthesized image.

The electronic device may output an edit menu 904 for an object, and perform an editing process on an input-detected menu. According to an embodiment, the electronic device may output a menu for removing a portion of an object, a menu for restoring a removed portion, a menu for applying a currently edited state to an object, and the like.

When the background around the object is removed via the editing process as described above, a natural synthesized image may be generated even when an object 907 overlaps as illustrated in FIG. 9C.

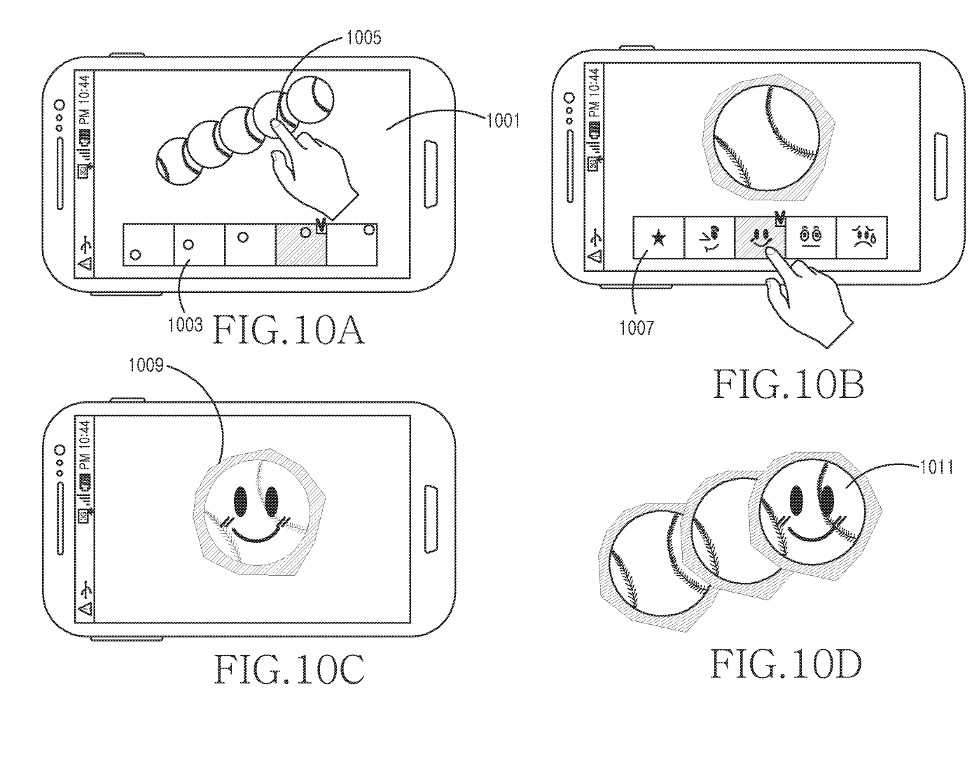

FIGS. 10A to 10D are views illustrating another process for editing an object forming a synthesized image in an electronic device according to an embodiment of the present disclosure.

Referring to FIG. 10A, the electronic device may output preview information 1003 forming a synthesized image together when outputting the synthesized image 1001.

The electronic device may detect an input for selecting an object to edit. According to an embodiment, the electronic device may determine selection of an object to edit by detecting an input for preview information output together with the synthesized image, or detecting an input for an object for the synthesized region.

For example, when detecting an input for the synthesized image as illustrated, the electronic device may determine and output an original image of the selected object.

The above-output original image may be edited by a user's input 1005. Here, the editing may be replacing an object of the selected original image by another image.

Referring to FIG. 10B, the electronic device may output an original image selected by a user, and output a list 1007 of edit methods applicable to the original image. Though an emoticon list that may be added to the original image has been output in the illustrated drawing, the electronic device may provide a list of stored other images. The electronic device may output a region detecting a user's input to add a figure, text, and the like, generated by the input to the original image.

The electronic device may output a list of editing methods, and detect an input to determine an editing method and apply the same to an object of the original image.

Referring to FIG. 10C, a smile effect 1009 is applied to an object selected by an input, and the electronic device may synthesize (1011) an object of the edited original image together with another object.

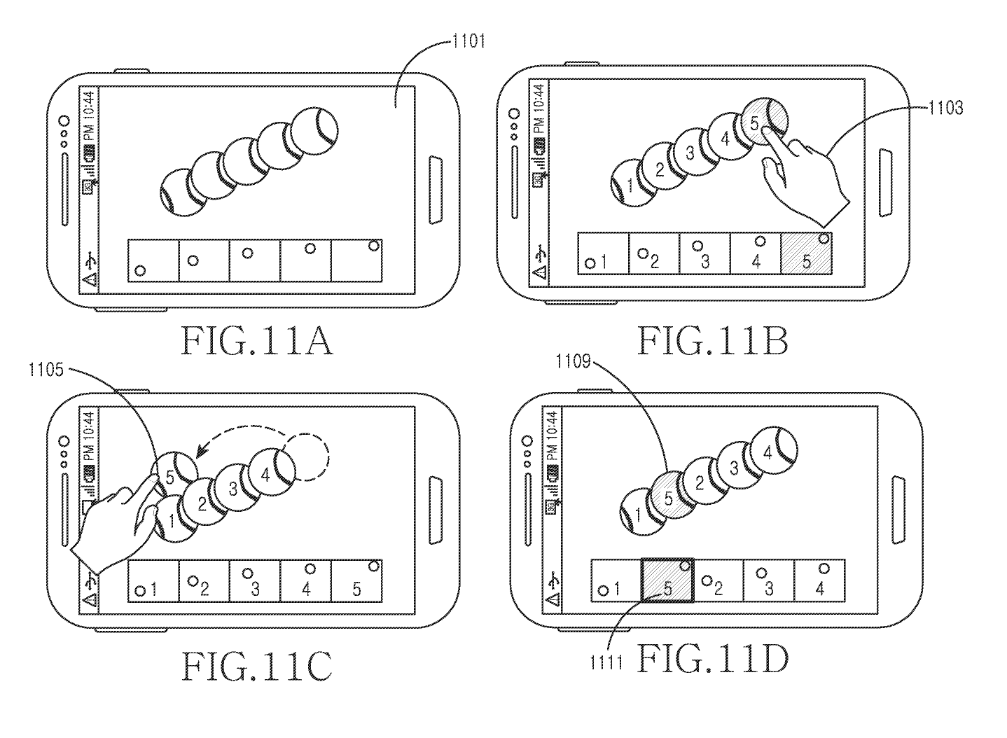

FIGS. 11A to 11D are views illustrating a process for editing a synthesized image in an electronic device according to an embodiment of the present disclosure.

Referring to FIG. 11A, the electronic device may output preview information forming a synthesized image together when outputting the synthesized image 1101.

In addition, the electronic device may detect an input for selecting an object to edit.

Referring to FIG. 11B, when detecting an input 1103 for a synthesized image, the electronic device may select an object to edit. When an object is selected by an input for the synthesized image, the electronic device may also activate preview information corresponding to the selected object.

Referring to FIG. 11C, the electronic device may detect an input for changing the position of the selected object. According to an embodiment, the electronic device may determine the changing position of an object by detecting a drag input 1105 with the object selected.

The illustrated drawing illustrates a circumstance where an original image corresponding to a fifth ball is moved between a first ball and a second ball.

Referring to FIG. 11D, the electronic device may change the position (sequence) of the original image for the selected object 1109. The electronic device may equally change the position of preview information 1111 corresponding to an object whose position has changed. The illustrated drawing illustrates a circumstance where a preview image for a fifth original image has moved between first and second original images.

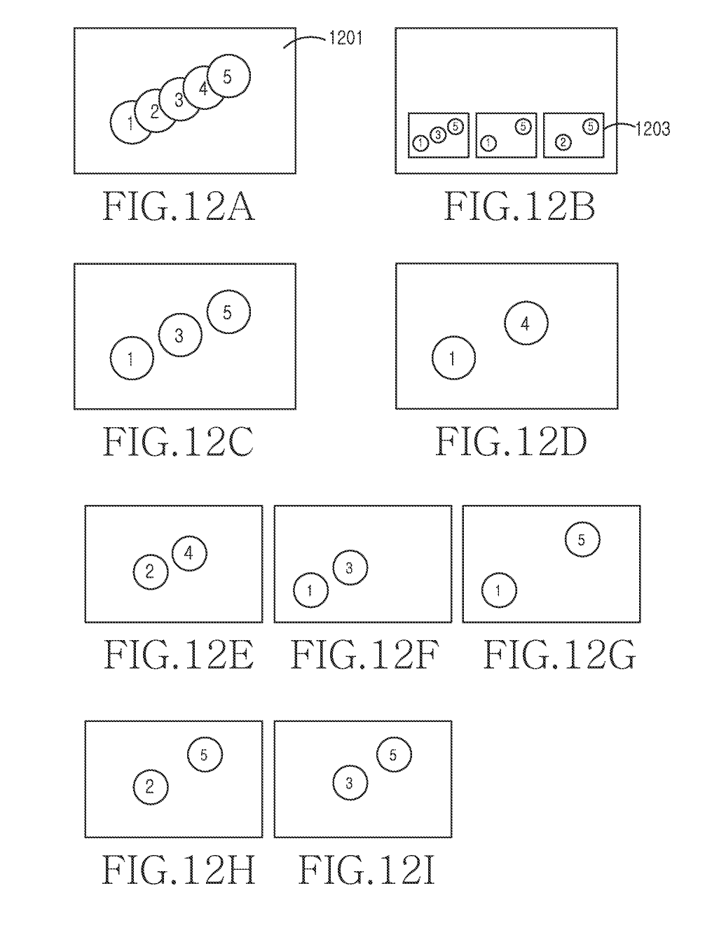

FIGS. 12A to 12I are views illustrating a process for generating a synthesized image in an electronic device according to an embodiment of the present disclosure.

The electronic device may compare successive images to determine an object whose state changes, and extract the determined object from a background.

The periphery of the extracted object may include a background of a predetermined region, and the electronic device may generate a synthesized image based on objects that do not overlap among extracted objects.

Referring to FIG. 12A, the electronic device may provide various kinds of candidate images based on an original image of an object that may be included in a synthesized image 1201. For example, the electronic device may determine a plurality of candidate images by changing a combination method under a circumstance where objects do not overlap, and perform an editing process on an object, so that the electronic device may generate a candidate image for the circumstance where the objects do not overlap. The electronic device may generate various kinds of candidate images while changing a combination method for an original image.

Referring to FIG. 12B, the electronic device may output preview information 1203 for the determined candidate image, and update an image of preview information selected by an input and using a synthesized image and output the same.

According to an embodiment, the electronic device may determine a candidate image using original images for first to fifth objects as illustrated in FIG. 12A. Examination of FIG. 12A shows a first object overlaps a second object but is separated from a third object, and the second object overlaps the first and third objects but is separated from a fourth object.

Referring to FIG. 12C, the electronic device determines a candidate image that combines objects such that they do not overlap each other. The electronic device may determine a candidate image using original images for the first object, the third object, and the fifth object.

Referring to FIG. 12C, the electronic device may determine a candidate image using original images for the first object and the fourth object as.

Referring to FIG. 12E, the electronic device may determine a candidate image using original images for the second object and the fourth object.

Referring to FIG. 12F, the electronic device may determine a candidate image using original images for the first object and the third object.

Referring to FIG. 12G, in addition, the electronic device may determine a candidate image using original images for the first object and the fifth object.

Referring to FIG. 12H, the electronic device may determine a candidate image using original images for the second object and the fifth object.

Referring to FIG. 12I, the electronic device may determine a candidate image using original images for the third object and the fifth object.

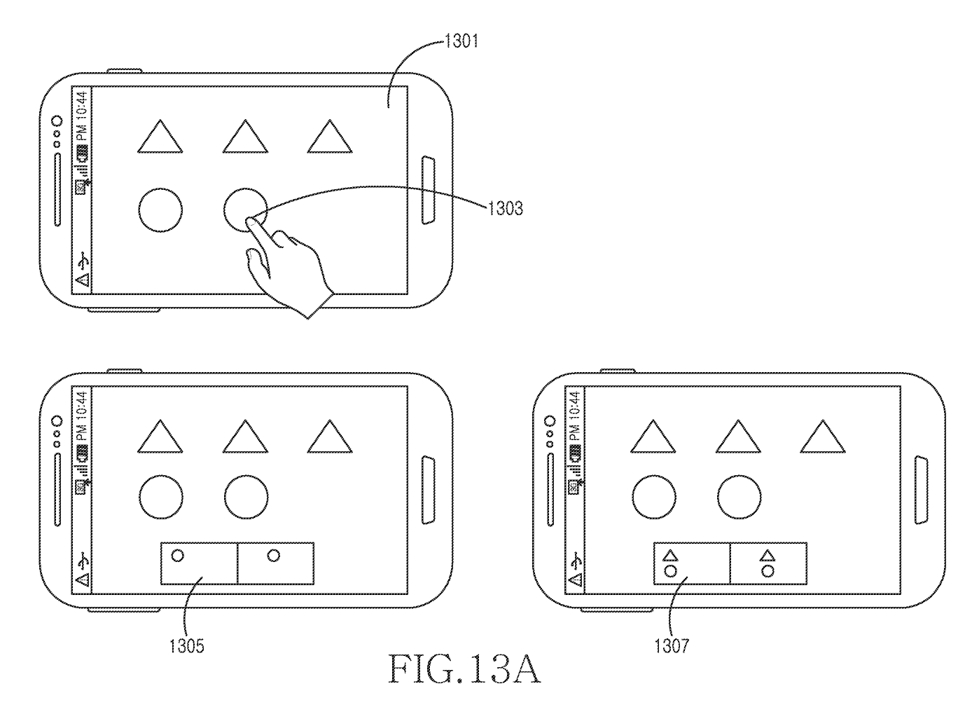

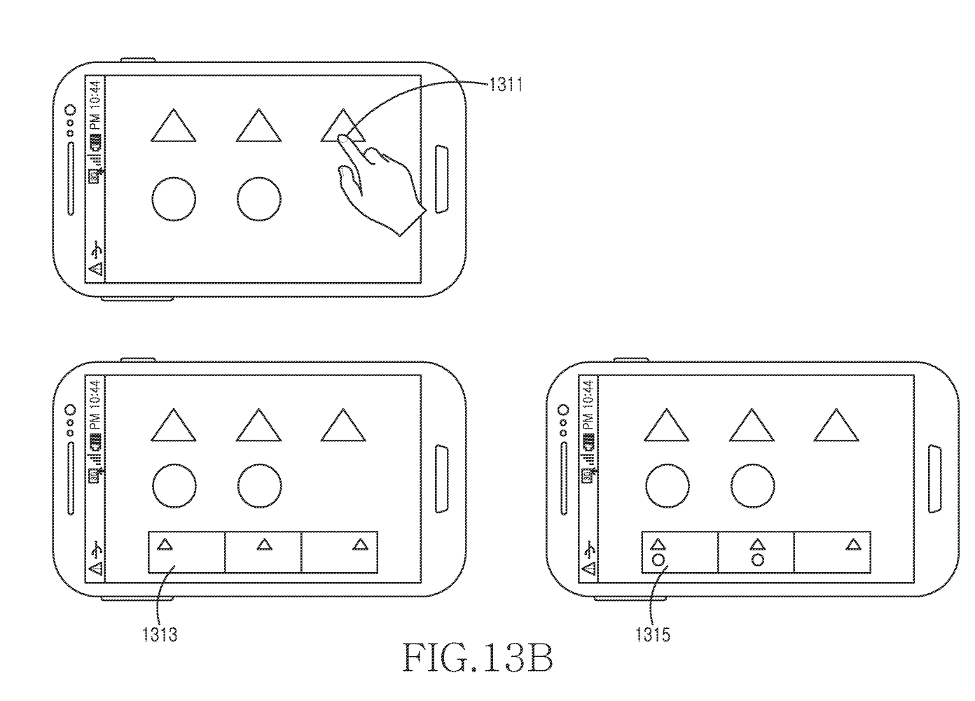

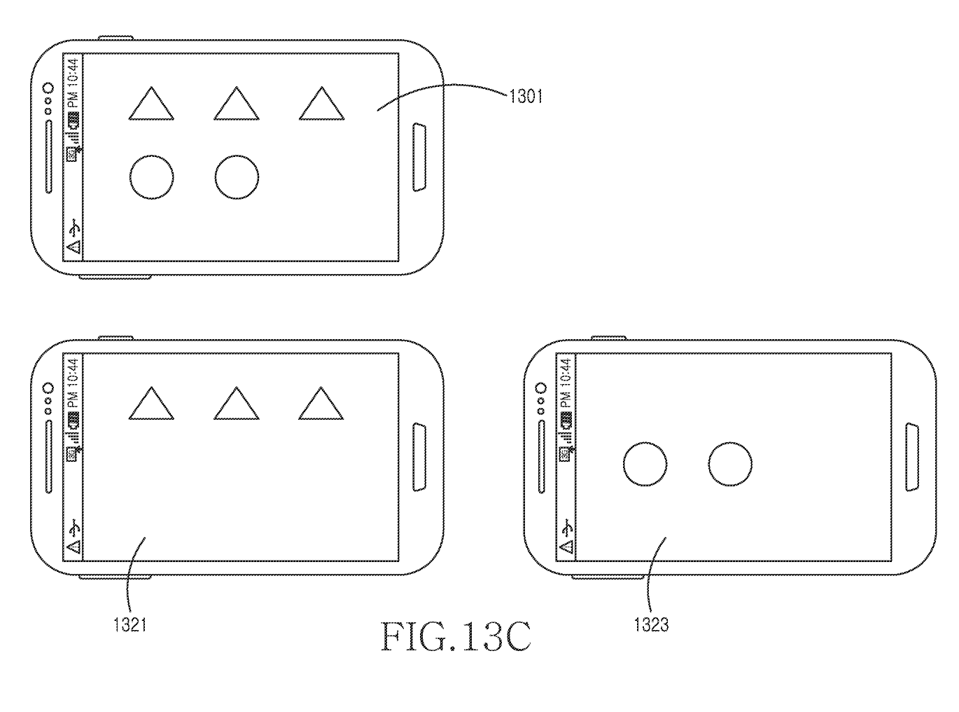

FIGS. 13A to 13C are views illustrating another process for generating a synthesized image in an electronic device according to an embodiment of the present disclosure.

The electronic device may output an image including a plurality of objects.

Referring to FIG. 13A, the electronic device may output an image 1301 expressing movement of a triangular object and a circular object, detect an input for this image, and output preview information based on an object selected by an input.

As illustrated in FIG. 13A, when detecting an input 1303 for selecting a circular object, the electronic device may output preview information 1305 of a circular object.

The electronic device may output preview information of an original image required for generating a synthesized image based on a state change of the selected object. That is, the electronic device may output preview information 1307 including a triangular object and a circular object at a point at which movement of the circular object changes.

Referring to FIG. 13B, when detecting an input 1311 for selecting a triangular object, the electronic device may output preview information 1313 of the triangular object.

The electronic device may output preview information of an original image required for generating a synthesized image based on a state change of the selected object. That is, the electronic device may output preview information 1315 including a triangular object and a circular object at a point at which movement of the triangular object changes.

The electronic device may generate a synthesized image using preview information of a selected object.

Referring to FIG. 13C, the electronic device may generate a synthesized image formed of a plurality of objects, and generate a synthesized image formed of at least one object. The electronic device may generate a synthesized image 1321 formed of only a triangular object, a synthesized image 1323 formed of only a circular object, or a synthesized image 1301 including both two objects as illustrated.

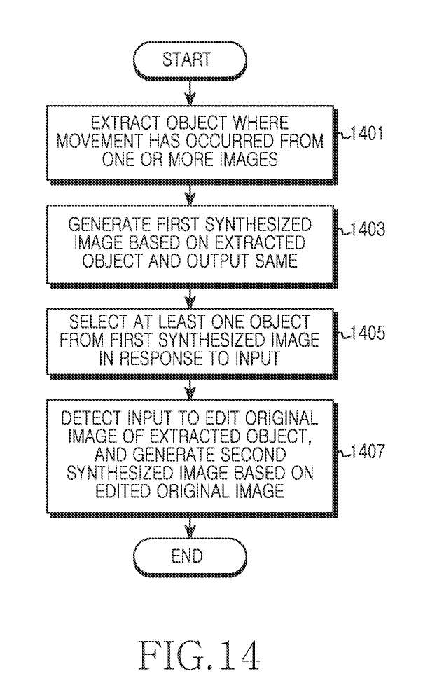

FIG. 14 is a flowchart illustrating a process for generating a synthesized image in an electronic device according to an embodiment of the present disclosure.

Referring to FIG. 14, the electronic device may extract an object whose movement has occurred from one or more images in operation 1401. The electronic device may shoot a moving object with a predetermined time interval with a shooting position fixed, and extract a moving object from each shot image.

The electronic device may generate and output a first synthesized image based on the extracted object in operation 1403. The electronic device may synthesize the extracted object in one background image, and generate a synthesized image where the movement of an object has been expressed. The first synthesized image is an image representing a synthesis result, and is not an actually generated synthesized image but a synthesized image before the image is stored in the electronic device.

The electronic device may select an object corresponding to an input in the output first synthesized image in operation 1405. The electronic device may output preview information of an object used for the synthesized image together when outputting the first synthesized image, and may detect an input for selecting an object of the output first synthesized image or an input for selecting the preview information to select an object corresponding to the input.

The electronic device may detect an input to edit an original image of the selected object, and generate a second synthesized image based on an object of the original image to output the same in operation 1407.

The electronic device may perform an editing process such as removal of a background included in a selected object, position change of an extracted object, deletion of an extracted object, duplication of an extracted object, and the like.

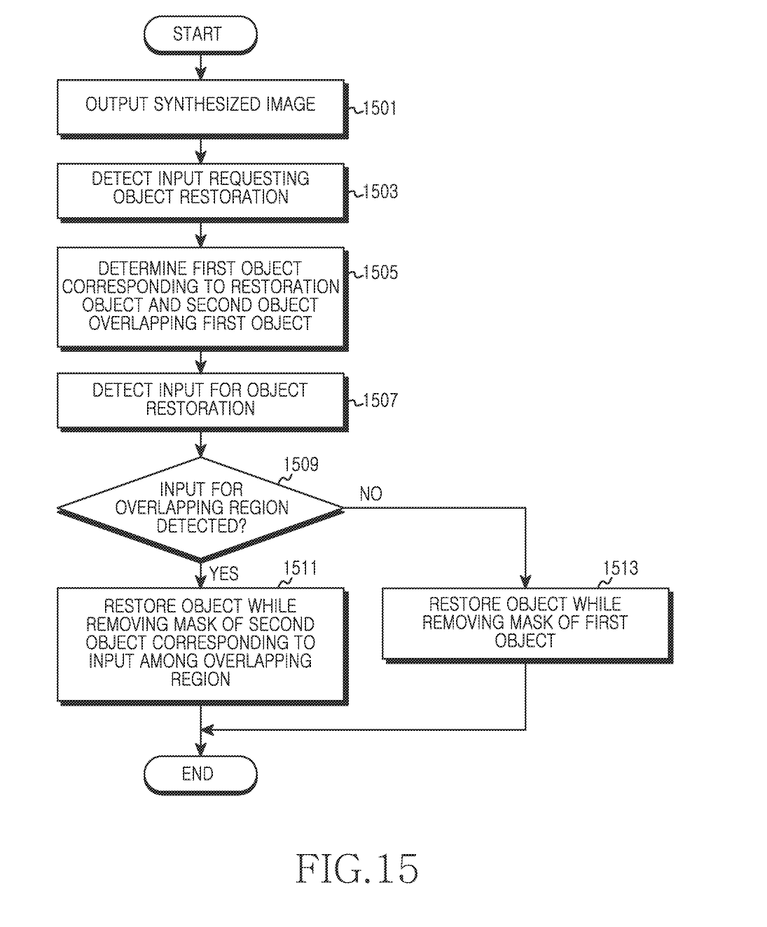

FIG. 15 is a flowchart illustrating a process for editing a synthesized image in an electronic device according to an embodiment of the present disclosure.

Referring to FIG. 15, the electronic device may extract an object from successively obtained (shot) images (original images) with respect to a moving object, and synthesize respectively extracted objects in one of images including a background.

The electronic device may output a synthesized image using a plurality of extracted objects in operation 1501. According to an embodiment, the synthesized image is an image representing a synthesis result, and is not an actually generated synthesized image but may be a synthesized image before the image is stored in the electronic device. According to an embodiment, the synthesized image may be an image of a state where layers of the object overlap each other. According to an embodiment, the electronic device may apply a masking effect to each image including the object. According to an embodiment, the electronic device may apply a masking effect to an object of each image and a background around the object.

The electronic device may detect an input requesting object restoration in operation 1503. According to an embodiment, the object restoration may be increasing a region to use for a synthesized image by removing a masking effect of an image including an object selected as an edit object. According to an embodiment, when detecting an input for selecting an object (an edit object), the electronic device may output a menu for selecting object restoration or object removal, and detect an input for the menu for object restoration.

The electronic device may determine a first object corresponding to a restoration object and a second object overlapping the first object in operation 1505.

The electronic device may detect an input for object restoration in operation 1507. According to an embodiment, an input for object restoration may be a touch input section.

The electronic device may determine whether an input for object restoration is detected in a region where the first object and the second object overlap in operation 1509. According to an embodiment, the overlapping region may be a region where the first object which is an object to edit and the second object disposed at an upper position than the first object overlap. According to an embodiment, the second object may be an object obtained after the first object has been obtained.

In the case where an input for object restoration is detected in a region where the two objects overlap, the electronic device may restore the first object while removing a mask (a masking effect) of the second object corresponding to an input among the overlapping region in operation 1511.

In the case where an input for object restoration is detected in a region of the first object where the two objects do not overlap, the electronic device may restore the first object while removing a mask of the first object that corresponds to the input in operation 1513.

The electronic device according to an embodiment of the present disclosure may remove a masking effect of the second object instead of the first object with respect to a region that overlaps the first object under a state where the first object corresponding to an edit object is selected.

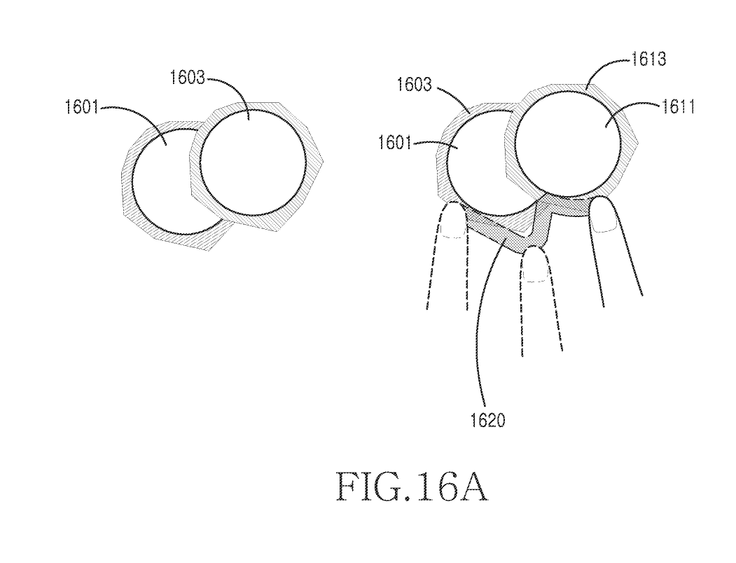

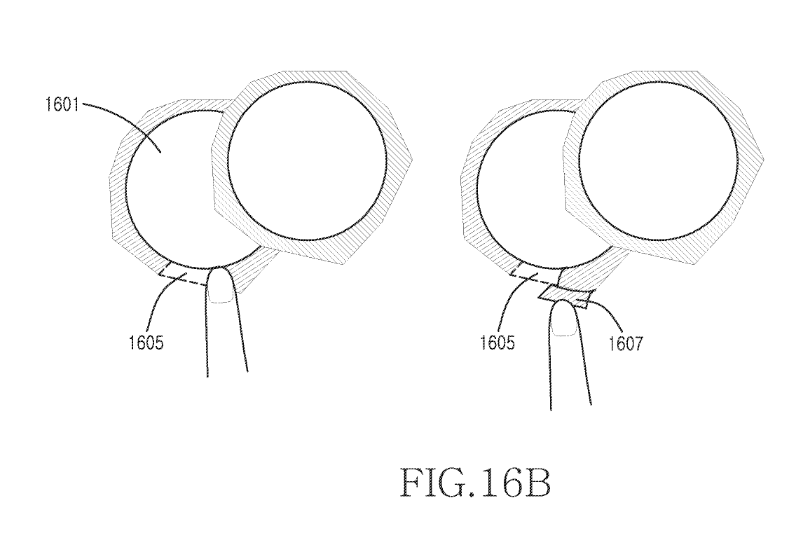

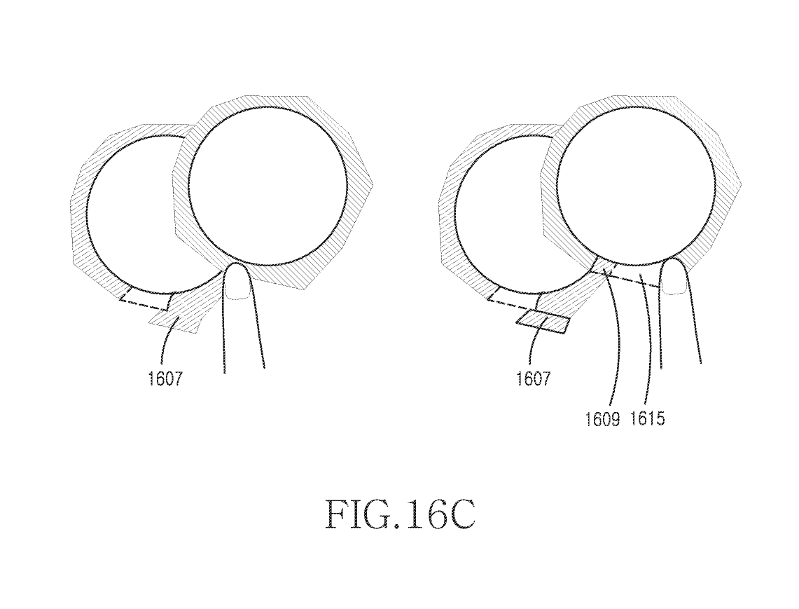

FIGS. 16A to 16C are views illustrating an image edit operation according to an embodiment of the present disclosure.

The electronic device may output a synthesized image that merges a plurality of objects in one image. A portion of an object included in the synthesized image may overlap another object. According to an embodiment, a synthesis sequence of the objects may be determined based on an obtained time sequence. According to an embodiment, an object whose obtain time is late may be disposed on an object whose obtain time is early. According to an embodiment, the object may be included in each layer.

The electronic device may select an object to edit. According to an embodiment, the electronic device may select the first object as an edit object when editing the first object, and select the second object as an edit object when editing the second object as illustrated in FIGS. 8 and 9.

Referring to FIG. 16A, the electronic device may edit the second object 1611 with the first object 1601 selected as an edit object. According to an embodiment, in the case where an edit section is included in the overlapping second object 1611 while the electronic device detects an input and edits an object selected as an edit object, the electronic device may edit the second object 1611.

According to an embodiment, the electronic device may determine an edit section with an object disposed at a lower position selected as an edit object. As illustrated, the electronic device may detect an input to determine a touch movement orbit from a touch detect point of a masking effect 1603 of the first object 1601 to a touch end point of a masking effect 1613 of the second object 1611 as an edit section 1620.

Referring to FIG. 16B, the electronic device may define an edit object based on the edit section and the position of an object. According to an embodiment, in the case where the edit section corresponds to the masking effect 1603 of the first object 1601, the electronic device may remove (1605) the masking effect of the first object 1601 for the edit section.

According to another embodiment, in the case where the edit section deviates from the masking effect 1603 of the first region 1601, the electronic device may extend (1607) the masking effect 1603 of the first region 1601 in response to the edit section.

Referring to FIG. 16C, in the case where the edit section corresponds to the masking effect of the second object 1611, the electronic device may remove (1615) the masking effect 1613 of the second object 1611 for the edit section. According to an embodiment, in a region where masking effects of two objects overlap as in the illustrated drawing, the masking effect 1613 of the second object 1611 is deleted, so that the masking effect 1609 of the first object 1601 may be exposed.

The electronic device may define an edit object based on an edit section and the position of an object even in case of restoring a removed masking effect.

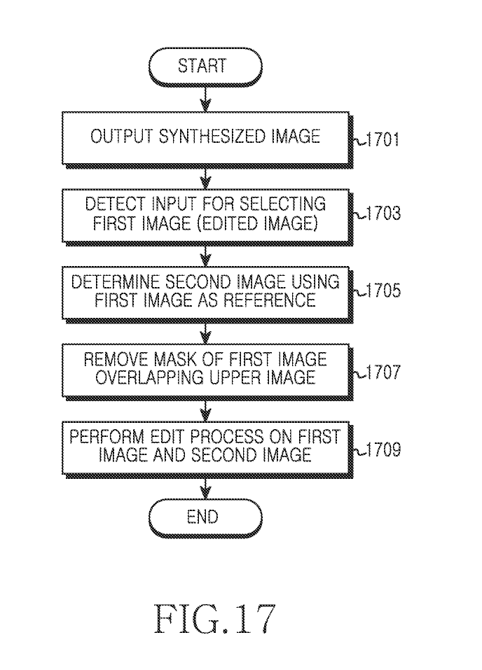

FIG. 17 is a flowchart illustrating a process for setting a masking effect in an electronic device according to an embodiment of the present disclosure.

Referring to FIG. 17, the electronic device may output a synthesized image in operation 1701. The synthesized image may be an image that merges a plurality of layers including respective objects. According to an embodiment, each layer may include an edit region to which a masking effect has been applied.

The electronic device may detect an input for selecting a first object (a first image) in operation 1703. The first object may be an object included in an image designated as an edit object.

The electronic device may determine a second object (a second image) using the first object as a reference in operation 1705. According to an embodiment, the second object may be an object disposed at an upper position among objects overlapping a portion of the first object.

The electronic device may remove a region overlapping the second object from a masking effect of the first object in operation 1707.

The electronic device may perform an editing process on the first object where a masking effect of a portion overlapping the second object has been removed, and the second object in operation 1709.

The electronic device according to an embodiment of the present disclosure processes to activate a masking effect disposed on an upper position with respect to an overlapping region to edit a selected first object in a region that does not overlap, and to edit a second object in a region that overlaps.

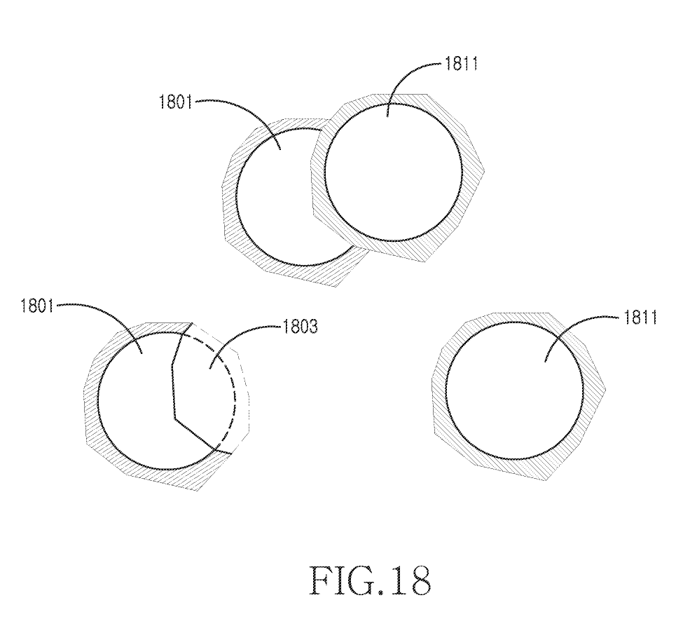

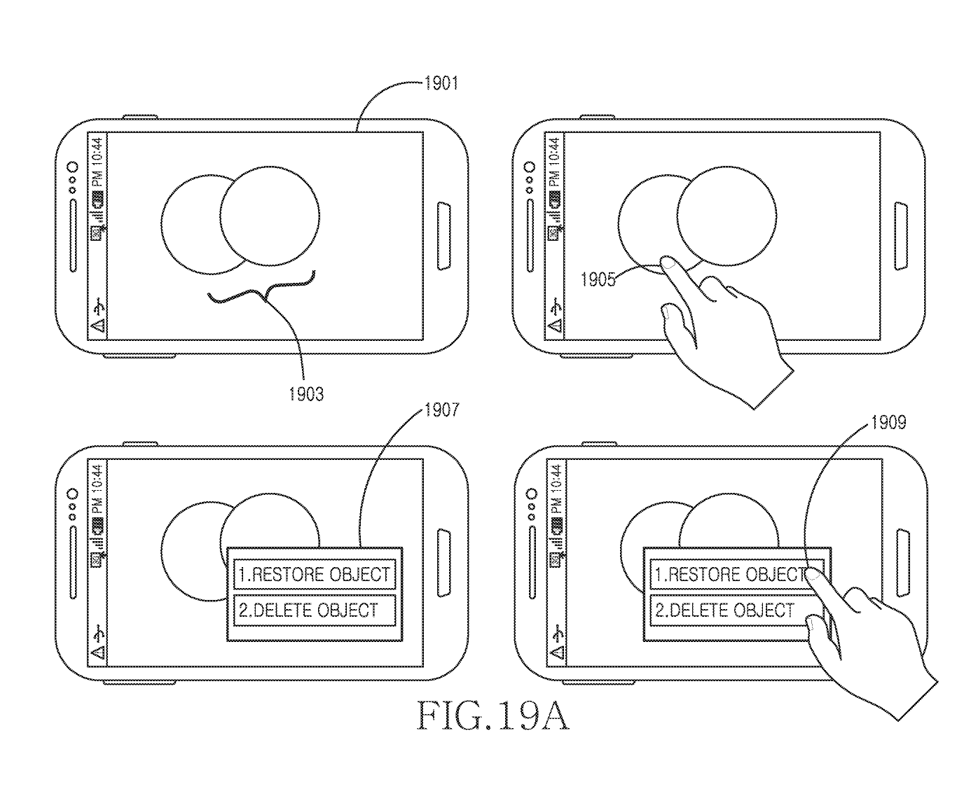

FIG. 18 is a view illustrating a masking effect of a synthesized image according to an embodiment of the present disclosure.

Referring to FIG. 18, when a second object 1811 overlapping a first object 1801 selected as an edit object is determined, the electronic device may remove a masking effect of the first object 1801 corresponding to the overlapping portion 1803 so that the masking effect does not overlap, and couple the first object with the second object 1811.

Even when the coupled first object 1801 and the second object 1811 overlap, the masking effect of each object does not overlap, so that the electronic device may detect a single input to edit the first object 1801 and the second object 1811.

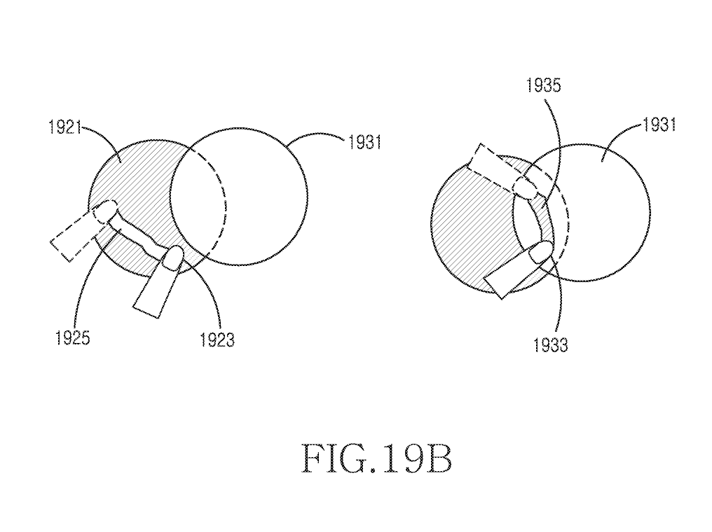

FIGS. 19A and 19B are views illustrating an object restoration process of an electronic device according to an embodiment of the present disclosure.

Referring to FIG. 19A, the electronic device may output a synthesized image 1903 formed of two objects to a display 1901. The electronic device may determine an input-detected object 1905 as an edit object, and when an object for object editing is determined, the electronic device may output (1907) a menu for editing object editing. According to an embodiment, the object editing may include object restoration and object deletion. According to an embodiment, the object restoration may be restoring a background included in an object. According to an embodiment, the object restoration may be performed by removing a mask effect of an image including an object. According to an embodiment, the object deletion may be deleting an object and a portion of a background included in the object. According to an embodiment, the object deletion may be performed while a removed mask effect is extended.

The electronic device may detect an input 1909 to perform an object restoration process on an output synthesized image.

Referring to FIG. 19B, the electronic device may detect an input to determine a first object 1921 among the output first object 1921 and second object 1931 that overlap each other as an edit object.

The electronic device may detect an object restoration input 1923 for the first object 1921 which is an edit object to restore a portion of the first object 1921. According to an embodiment, as illustrated, the electronic device may remove (1925) a masking effect of the first object 1921 corresponding to an input with respect to a restoration input for the first object 1921.

The electronic device may detect an object restoration input for a region where two object overlap to restore a portion of the first object 1921 corresponding to an input. According to an embodiment, as illustrated, the electronic device may remove (1935) a masking effect of the second object 1931 disposed at an upper position than the first object 1921 with respect to a restoration input 1933 for a region where the two objects overlap. The illustrated drawing illustrates a portion of the second object 1931 is deleted by a removed masking effect of the second object 1931, and the first object 1921 hidden by the second object 1931 before deletion is exposed.

According to an embodiment, a method for outputting an image in an electronic device may include a process for extracting an object where movement has occurred from one or more images, a process for generating and outputting a first synthesized image based on the extracted object, a process for selecting at least one object from a first synthesized image in response to an input, and a process for detecting an input, editing an original image of the selected object, and generating a second synthesized image based on an object of an edited original image.

According to an embodiment, the method may include a process for outputting preview information for an object used for a synthesized image when outputting the first synthesized image, and defining an original image for input-detected preview information as an edit object.

According to an embodiment, the method may detect an input for the first synthesized image to determine an object to edit, and define an original image for the determined object as an edit object.

According to an embodiment, at least the neighbor background of the original image may be removed depending on an input.

According to an embodiment, the position of an object selected from the first synthesized image is changed depending on an input, and in the case where the position of the object changes with preview information output, arrangement of preview information may also change in response to the position change.

According to an embodiment, the first synthesized image may include a plurality of objects, and preview information based on the selected first object may be output in response to an input.

According to an embodiment, the electronic device may provide preview information of one or more candidate images when generating the first synthesized image.

According to an embodiment, a candidate image for preview information selected by an input may be used as a second synthesized image.

According to an embodiment, the process for detecting the input, and editing the original image of the selected object may include defining an edit object based on an edit section and an overlapping state of the first original image selected as an edit object.

According to an embodiment, the process for detecting the input, and editing the original image of the selected object may include, in the case where an edit section deviates from the first original image with a first original image disposed at a lower position than an overlapping second original image, extending a region of the first original image corresponding to an edit section.

According to an embodiment, the process for detecting the input, and editing the original image of the selected object may include, in the case where an edit section is included in a region that overlaps a second original image with a first original image disposed at a lower position than the overlapping second original image, removing a region of the second original image corresponding to an edit section.

According to an embodiment, the method may include an editing process for applying a masking effect on an original image defined as the edit object, and removing a masking effect for a region corresponding to an input or restoring a removed masking effect.

According to an embodiment, the process for detecting the input, and editing the original image of the selected object may include a process for applying a masking effect to the original image defined as the edit object, and in the case where the first original image defined as the edit object overlaps a second original image, removing the masking effect of the first original image with respect to the overlapping portion.

Each of the above-described elements of the electronic device according to the present disclosure may include one or more components, and a name of a relevant component may change depending on a kind of an electronic device. An electronic device according to the present disclosure may include at least one of the above-described elements, some of the elements may be omitted, or the electronic device may further include additional other elements. Also, some of the elements of the electronic device according to the present disclosure may couple to form one entity, so that the entity may equally perform the functions of the relevant elements before the coupling.

A terminology element used for the present disclosure, for example, a “module”, for example, may denote a unit including one or more combinations of a software and a firmware. A “module”, for example, may be interchangeably used with a terminology such as a unit, a logic, a logical block, a component, or a circuit, and the like. A “module” may be a minimum unit or a portion thereof performing one or more functions. A “module” may be implemented mechanically or electronically. For example, a “module” according to the present disclosure may include at least one of an Application-Specific Integrated Circuit (ASIC) chip performing certain operations, a Field-Programmable Gate Arrays (FPGAs), or a programmable-logic device which is known or to be developed in the future.

According to an embodiment, at least a portion of an apparatus (ex: modules or functions thereof) or a method (ex: operations) according to the present disclosure, for example, may be implemented as instructions stored in a computer-readable storage media in the form of a programming module. When executed by one or more processors, the instruction allows the one or more processors to perform a function corresponding to the instruction. The computer-readable storage media, for example, may be a memory. At least a portion of the programming module, for example, may be implemented (ex: executed) by the processor. At least a portion of the programming module, for example, may include a module, a program, a routine, a set of instructions, a process, and/or the like, for performing one or more functions.

The computer-readable storage medium may include a hard disk, a magnetic media such as a floppy disk and a magnetic tape, an optical media such as a Compact Disc Read Only Memory (CD-ROM) and a Digital Versatile Disc (DVD), a magneto-optical media such as a floptical disk, and a hardware device specially configured for storing and performing a program instruction (ex: a programming module) such as Read Only Memory (ROM), a Random Access Memory (RAM), a flash memory, and the like. Also, the program instruction may include not only a machine language code such as things generated by a compiler but also a high-level language code executable by a computer using an interpreter, and the like. The above hardware device may be configured to operate as one or more software modules in order to perform an operation of the present disclosure, and vice versa.

A module or a programming module according to the present disclosure may include at least one of the above-described elements, or some of the elements may be omitted, or the module may further include additional other elements. Operations performed by the module, the programming module, and other elements according to the present disclosure may be executed sequentially, in parallel, repeatedly, or a heuristic method. Also, a portion of operations may be executed in a different sequence, or omitted, or another operation may be added.

According to an embodiment, in a storage medium storing instructions, the instructions are set, when executed by at least one processor, to allow the at least one processor to perform at least one operation. The at least one operation may include an operation of extracting an object where movement has occurred from one or more images, an operation of generating a first synthesized image based on the extracted object and outputting the same, an operation of selecting at least one object from the first synthesized image in response to an input, and an operation of detecting an input to edit an original image of the selected object, and generating a second synthesized image based on an object of the edited original image.

According to an embodiment, an electronic device may remove a neighboring background included in an object forming a synthesized image to increase the number of objects included in the synthesized image.

In addition, the electronic device may select an original image to edit using an input for a synthesized image.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display; and
a processor,
wherein the processor is configured to output a first synthesized image expressing a state of an object via the display, to output preview information regarding an object used for the first synthesized image, to select at least one object from the first synthesized image in response to an input, to detect an input to edit an original image corresponding to the selected at least one object, and to generate and output a second synthesized image based on an object of the edited original image.

2. The electronic device of claim 1, wherein the processor is further configured to detect at least one of an input for the first synthesized image and an input for the preview information to determine an original image for an object to edit.

3. The electronic device of claim 1, wherein the processor is further configured to remove or add a background around an object from or to an original image corresponding to the selected at least one object.

4. The electronic device of claim 1, wherein the processor is further configured to change a position of the selected at least one object using an input for the first synthesized image, and change arrangement of preview information in response to a changed position.

5. The electronic device of claim 1, wherein the processor is further configured to determine an object selected by an input in an image comprising a plurality of objects, and provide preview information based on the selected at least one object.

6. The electronic device of claim 1, wherein the processor is further configured to change a combination of the original image to generate a candidate image, and output the preview information of the generated candidate image.

7. The electronic device of claim 6, wherein the processor is further configured to use the candidate image for preview information selected by an input as a second synthesized image.

8. The electronic device of claim 1, wherein the processor is configured to select an object to edit from the first synthesized image, and apply an effect to the preview information of the selected at least one object.

9. A method for outputting an image in an electronic device, the method comprising:
extracting an object where a movement has occurred from one or more images;
generating and outputting a first synthesized image based on the extracted object;
selecting at least one object from the first synthesized image in response to an input; and
detecting an input to edit an original image of the selected at least one object, and generating a second synthesized image based on an object of the edited original image.

10. The method of claim 9, further comprising:
outputting preview information of an object used for the synthesized image when outputting the first synthesized image,
wherein an original image for input-detected preview information is defined as an edit object.

11. The method of claim 9, further comprising:
detecting an input for the first synthesized image to determine an object to edit,
wherein the original image for the determined object is defined as an edit object.

12. The method of claim 9, wherein at least a neighbor background of the original image is moved depending on an input.

13. The method of claim 9, wherein a position of an object selected from the first synthesized image is changed depending on an input, and in the case where the position of the object is changed with preview information output, arrangement of the preview information is also changed in response to the changed position.

14. The method of claim 9, wherein the first synthesized image comprises a plurality of objects, and preview information based on a first object selected in response to an input is output.

15. The method of claim 9, further comprising:
providing preview information of at least one candidate image when generating the first synthesized image.

16. The method of claim 15, wherein the candidate image for the preview information selected by an input is used as a second synthesized image.

17. The method of claim 9, wherein the detecting of the input to edit the original image of the selected at least one object comprises:
defining an edit object based on an edit section and an overlapping state of a first original image selected as an edit object.

18. The method of claim 17, wherein the detecting of the input to edit the original image of the selected at least one object comprises:
in the case where the edit section deviates from the first original image with the first original image disposed at a lower position than an overlapping second original image, extending a region of the first original image that corresponds to the edit section.

19. The method of claim 17, wherein the detecting of the input to edit the original image of the selected at least one object comprises:
in the case where the edit section is included in a region overlapping a second original image with the first original image disposed at a lower position than an overlapping second original image, removing a region of the second original image that corresponds to the edit section.

20. The method of claim 17, further comprising:
an editing process for applying a masking effect to an original image defined as the edit object, and removing a masking effect of a region corresponding to an input or restoring a removed masking effect.

21. The method of claim 17, wherein the detecting of the input to edit the original image of the selected at least one object comprises:
applying a masking effect to the original image defined as the edit object, and in the case where the first original image defined as the edit object overlaps a second original image, removing a masking effect of the first original image for an overlapping portion.

22. A non-transitory computer-readable storage medium storing instructions that, when executed, cause at least one processor to perform the method of claim 9.
